(19) United States
(12) Patent Application Publication
(10) Pub. No.: US 2010/0159932 A1
(43) Pub. Date: Jun. 24, 2010

(54) METHOD AND SYSTEM FOR CONTROLLING HANDOVER BASED ON WIRELESS LINK QUALITY

(75) Inventors: Hyun-seo Park, Daejeon-si (KR); Yeon-seung SHIN, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon-si (KR)

(21) Appl. No.: 12/580,285

(22) Filed: Oct. 16, 2009

(30) Foreign Application Priority Data
Dec. 18, 2008 (KR) 10-2008- 0129343

(51) Int. Cl. H04W 36/00

(52) U.S. Cl. 455/436

(57) ABSTRACT

A method and system for controlling handover based on a quality of a wireless link of a mobile terminal is provided. The method includes requesting the mobile terminal to measure a quality of a wireless link, receiving a report message about a measured wireless link quality from the mobile terminal, determining a target base station based on the report message about the measured wireless link quality, and determining an optimum handover scheme according to wireless link quality between the target base station and the mobile terminal and between the serving base station and the mobile terminal to make a handover.

### CROSS-REFERENCE TO RELATED APPLICATION

This application claims the benefit under 35 U.S.C. §119(a) of Korean Patent Application No. 10-2008-0129343, filed on Dec. 18, 2008, the disclosure of which is incorporated by reference in its entirety for all purposes.

### BACKGROUND

1. Field

The following description relates to a mobile communication system and, more particularly, to a method and system for controlling handover based on a wireless link quality of a mobile terminal.

2. Description of the Related Art

In cellular telecommunications, the term handover refers to the process of transferring an ongoing call or data session from one channel connected to the core network to another when a mobile terminal moves between cells.

Handover in 3GPP LTE (3^{rd} Generation Partnership Project Long Term Evolution) standards is the same as handover in cellular telecommunications. More specifically, for a mobile terminal to make a handover from a serving base station to a target base station, the mobile terminal breaks a connection with the serving base station and attempts a connection to the target base station. Such handover may also be referred to as hard handover. At hard handover, to receive data sent to the serving base station, the serving base station sends the data to the target base station and the target base station buffers the data therein. When the mobile terminal is connected to the target base station, the target base station sends the buffered data to the mobile terminal. Hence, the mobile terminal can receive the data sent to the serving base station at handover.

However, when the mobile terminal is receiving multiple services, handover is typically performed simultaneously for every service flow. In this case, a transmission error may occur for a particular service. For example, for a service flow requiring a real-time service, a real-time service quality is preferably guaranteed; for a service flow requiring a non-real-time, errorless service, a minimal transmission error is preferably guaranteed by performing handover after the mobile terminal has received data from the serving base station.

### SUMMARY

The following description relates to a handover control method and system that determines an optimum handover scheme based on a quality of a wireless link of a mobile terminal to minimize a transmission error.

In addition, the following description relates to a handover control method and system that determines an optimum handover scheme for each service at a different time.

In one general aspect, a method of controlling handover of a serving base station connected to a mobile terminal includes requesting the mobile terminal to measure a quality of a wireless link; receiving a report message about a measured wireless link quality from the mobile terminal; determining a target base station based on the report message about the measured wireless link quality; and determining an optimum handover scheme according to wireless link quality between the target base station and the mobile terminal and between the serving base station and the mobile terminal to make a handover.

If the wireless link quality between the target base station and the mobile terminal and between the serving base station and the mobile terminal is greater than a predetermined threshold quality, partial handover may be performed for each service received by the mobile terminal.

The mobile terminal may be requested to make an immediate handover to the target base station for a service requiring a real-time service quality when the partial handover is performed.

For a service requiring a non-real-time service quality when the partial handover is performed, the mobile terminal may be requested to make a handover to the target base station after data is completely received.

If the wireless link quality between the target base station and the mobile terminal and between the serving base station and the mobile terminal is below a predetermined threshold quality, macro diversity handover may be performed where data is requested to be sent from both the target base station and the serving base station to the mobile terminal.

In another general aspect, a system for controlling handover based on a quality of a wireless link includes a serving base station to request a mobile terminal to check quality of wireless links to neighboring base stations, to determine an optimum handover scheme based on the wireless link quality received from the mobile terminal, and to request handover from the mobile terminal; a target base station to receive a handover confirm message from the mobile terminal and to instruct path switch; and a gateway to receive a path switch request from the target base station and to switch a data path for each service to enable the serving base station and/or the target base station to receive data for each service.

When receiving a macro diversity handover confirm message from the mobile terminal, the target base station may send a bicasting request message to request the gateway to send the same data as that sent to the serving base station.

If the wireless link quality between the target base station and the mobile terminal and between the serving base station and the mobile terminal is greater than a predetermined threshold quality, the serving base station may request handover at a different time for each service received by the mobile terminal.

However, other features and aspects will be apparent from the following description, the drawings, and the claims.

### BRIEF DESCRIPTION OF THE DRAWINGS

FIGS. 1A to 1C are flowcharts illustrating an exemplary method of selecting a handover scheme and making a handover according to the selected handover scheme.

FIG. 2 is a flow diagram illustrating an exemplary partial handover process.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

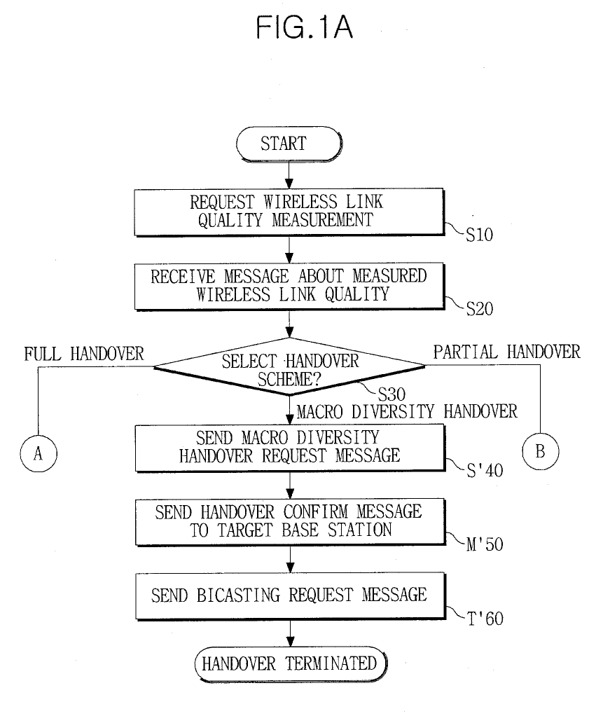

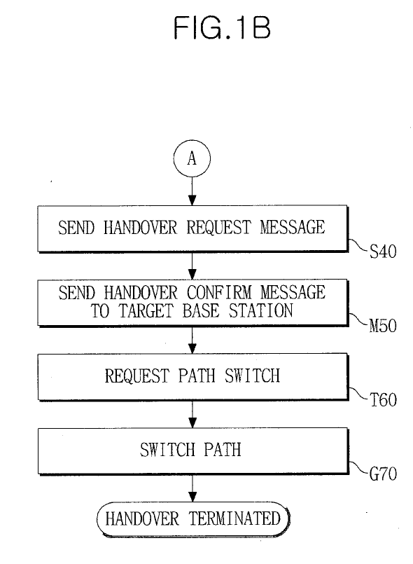

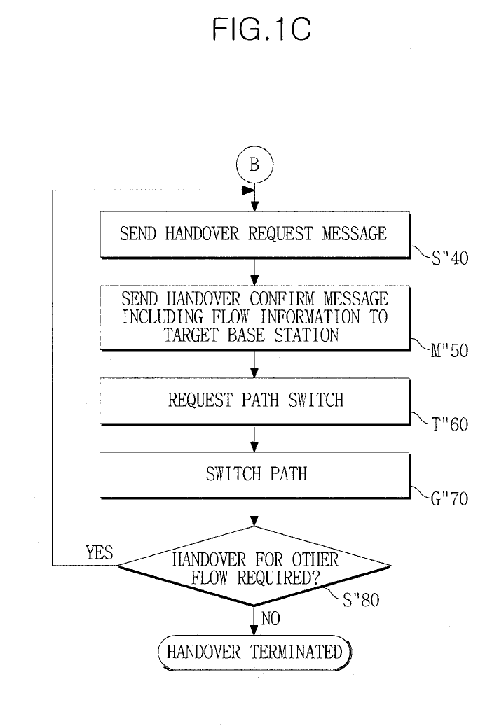

FIGS. 1A to 1C are flowcharts illustrating an exemplary method of selecting a handover scheme and making a handover according to the selected handover scheme. In FIGS. 1A to 1C, ‘S’ denotes operations in a serving base station; ‘M’ denotes operations in a mobile terminal; ‘T’ denotes operations in a target base station; G′ denotes operations in a gateway which corresponds to a mobility anchor.

Referring to FIG. 1A, it is assumed that a mobile terminal accesses a serving base station and receives a service from the serving base station.

The serving base station requests the mobile terminal to measure the quality of wireless links in a serving cell and neighboring cells and inform the serving base station of the measurement result (operation S10).

The mobile terminal measures the quality of wireless links in the serving cell and the neighboring cells and sends the measurement result to the serving base station in form of message (operation S20). Based on the measurement result, the serving base station determines a target base station to be handed over and selects a handover scheme appropriate for the mobile terminal (operation S30). Examples of the handover scheme include full handover, macro diversity handover and partial handover.

The term full handover refers to a handover scheme which is selected when a signal quality between a mobile terminal and a serving base station is below a threshold quality and a signal quality between a mobile terminal and a target base station is greater than the threshold quality. The term macro diversity handover refers to a handover scheme which is selected when a signal quality between a mobile terminal and a serving base station is below a threshold quality and a signal quality between a mobile terminal and a target base station is also below the threshold quality. The term partial handover refers to a handover scheme which is selected when a signal quality between a mobile terminal and a serving base station is greater than a threshold quality and a signal quality between a mobile terminal and a target base station is also greater than the threshold quality.

Full handover, macro diversity handover and partial handover will now be described in more detail.

The serving base station checks the quality of wireless links between the mobile terminal and each of the serving base station and the target base station. If the wireless link quality of the serving base station is greater than a predetermined threshold quality but the wireless link quality of the target base station is below the threshold quality, the serving base station will not make a handover. However, if the wireless link quality of the serving base station is below the threshold quality but the wireless link quality of the target base station is greater than the threshold quality, full handover is determined to be optimal and the handover process proceeds to operation S40 in FIG. 1B.

In operation S40, the serving base station sends a handover request message to the mobile terminal. The handover request message includes information about the handover type and the target base station. After receiving the handover request message, the mobile terminal sends a handover confirm message to the target base station (operation M50) to inform the target base station of the handover request. The target base station requests path switch from a gateway corresponding to a mobility anchor (operation T60) so that a data path to the serving base station may be switched to a data path to the target base station. The gateway switches the data path from the serving base station to the target base station (operation G70). As such, the full handover process is terminated.

On the other hand, if macro diversity handover is determined to be optimal in operation S30, the serving base station sends a macro diversity handover request message to the mobile terminal (operation S′40). The handover request message also includes information about the handover type and the target base station. After receiving the macro diversity handover request message, the mobile terminal sends a macro diversity handover confirm message to the target base station (operation M′50) to inform the target base station of the handover request. The target base station sends a bicasting request message to the gateway corresponding to a mobility anchor (operation T′60). The bicasting request message includes information about the target base station. The gateway transmits to the target base station the same data as that sent to the serving base station. As such, the macro diversity handover process is terminated.

On the other hand, if partial handover (also referred to as flow handover) is determined to be optimal in operation S30, the serving base station sends a partial handover request message to the mobile terminal on a service flow basis (operation S″40). The handover request message includes information about the handover type, the target base station and a flow in service. After receiving the partial handover request message, the mobile terminal sends a partial handover confirm message containing flow information to the target base station (operation M″50) to inform the target base station of the handover request. The target base station requests path switch for the service flow from the gateway corresponding to a mobility anchor (operation T″60). The gateway switches a data path from the serving base station to the target base station (operation G″70). As such, the partial handover process is terminated for the first service flow.

If it is determined that handover needs to be further performed on a service flow basis (operation S″80), the process returns to operation S″40 and the target base station resends to the mobile terminal a partial handover request message for the remaining service flow. Subsequently, operations M″50, T″60, G″70 and S″80 are repeated. As such, the partial handover process is terminated for each service flow at a different time.

The partial handover guarantees a real-time service quality for a service flow requiring a real-time service. In addition, the partial handover guarantees a minimal transmission error for a service flow requiring a non-real-time, errorless service, since handover is performed after the mobile terminal receives data from the serving base station.

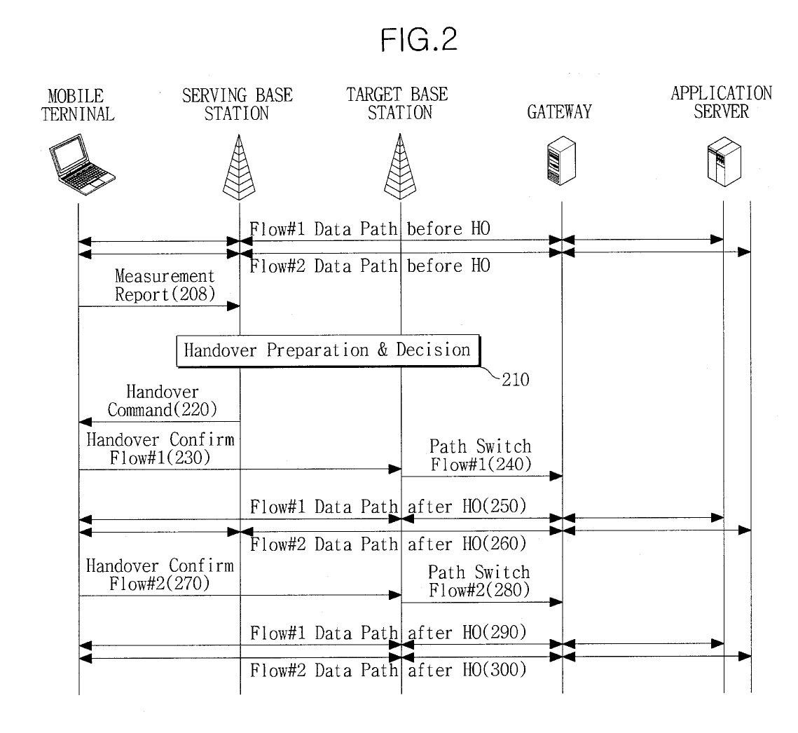

The partial handover process will now be described in more detail with reference to FIG. 2.

It is assumed that a mobile terminal M receives different service flows from different application servers APs through a serving base station S and a gateway G corresponding to a mobility anchor. In this case, there are two data paths for two service flows Flow#1 and Flow#2 between the mobile terminal and the serving base station.

When the serving base station requests the mobile terminal to measure the quality of a wireless link, the mobile terminal measures the wireless link quality and informs the serving base station of the measured wireless link quality (operation 208). The serving base station determines an optimum handover scheme based on the wireless link quality (operation 210). If partial handover is determined to be optimum, the serving base station sends a handover request message for a first service flow Flow#1 to the mobile terminal (operation 220). The handover request message includes information about the handover type and the flow in service.

After receiving the partial handover request message, the mobile terminal makes a handover for the service flow Flow#1 based on the handover type information. More specifically, the mobile terminal sends to a designated target base station a handover confirm message containing the information about the flow Flow#1 (operation 230) to inform the target base station of the handover request. The target base station requests path switch for the service flow Flow#1 from the gateway (operation 240). The gateway switches a data path from the serving base station to the target base station. As such, the partial handover process is terminated for the first service flow Flow#1. As a result, a data path is established between the mobile terminal and the target base station (operation 250). A data path for the other service flow Flow#2 has not changed (operation 260).

If data has been transmitted to the serving base station for the service flow Flow#2 requiring a non-real-time, errorless service, the serving base station sends to the mobile terminal a partial handover request message for the service flow Flow#2.

After receiving the partial handover request message for the service flow Flow#2, the mobile terminal to a designated target base station a handover confirm message containing the information about the flow Flow#2 (operation 270) to inform the target base station of the handover request. The target base station requests path switch for the service flow Flow#2 from the gateway (operation 280). The gateway switches a data path from the serving base station to the target base station. As such, the partial handover process is terminated for the second service flow Flow#2. As a result, a data path is established between the mobile terminal and the target base station (operation 300). A data path for the other service flow Flow#1 remains the same as it used to be (operation 290).

As apparent from the above description, it is possible to improve the service quality and to minimize the transmission error by determining an optimum handover scheme based on a quality of a wireless link of a mobile terminal.

In particular, the partial handover guarantees a real-time service quality for a service flow requiring a real-time service. In addition, the partial handover guarantees a minimal transmission error for a service flow requiring a non-real-time, errorless service, since handover is performed after the mobile terminal receives data from serving base station.

Accordingly, it is possible to provide an optimum performance by providing a different handover scheme for each of requested services based on the wireless link quality between the mobile terminal and the serving and target base stations.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling handover of a serving base station connected to a mobile terminal, comprising:
requesting the mobile terminal to measure a quality of a wireless link;
receiving a report message about a measured wireless link quality from the mobile terminal;
determining a target base station based on the report message about the measured wireless link quality; and
determining an optimum handover scheme according to wireless link quality between the target base station and the mobile terminal and between the serving base station and the mobile terminal to make a handover.

2. The method of claim 1, wherein if the wireless link quality between the target base station and the mobile terminal and between the serving base station and the mobile terminal is greater than a predetermined threshold quality, partial handover is performed for each service received by the mobile terminal.

3. The method of claim 2, wherein the mobile terminal is requested to make an immediate handover to the target base station for a service requiring a real-time service quality when the partial handover is performed.

4. The method of claim 2, wherein for a service requiring a non-real-time service quality when the partial handover is performed, the mobile terminal is requested to make a handover to the target base station after data is completely received.

5. The method of claim 1, wherein if the wireless link quality between the target base station and the mobile terminal and between the serving base station and the mobile terminal is below a predetermined threshold quality, macro diversity handover is performed where data is requested to be sent from both the target base station and the serving base station to the mobile terminal.

6. The method of claim 1, wherein if the wireless link quality between the target base station and the mobile terminal is greater than a predetermined threshold quality and the wireless to link quality between the serving base station and the mobile terminal is below the predetermined threshold quality, the mobile terminal is requested to make a full handover to the target base station.

7. A system for controlling handover based on a quality of a wireless link, comprising:
is a serving base station to request a mobile terminal to check quality of wireless links to neighboring base stations, to determine an optimum handover scheme based on the wireless link quality received from the mobile terminal, and to request handover from the mobile terminal;
a target base station to receive a handover confirm message from the mobile terminal and to instruct path switch; and
a gateway to receive a path switch request from the target base station and to switch a data path for each service to enable the serving base station and/or the target base station to receive data for each service.

8. The system of claim 7, wherein when receiving a macro diversity handover confirm message from the mobile terminal, the target base station sends a bicasting request message to request the gateway to send the same data as that sent to the serving base station.

9. The system of claim 7, wherein if the wireless link quality between the target base station and the mobile terminal and between the serving base station and the mobile terminal is greater than a predetermined threshold quality, the serving base station requests handover at a different time for each service received by the mobile terminal.
